(19) United States
(12) Patent Application Publication
(10) Pub. No.: US 2019/0005533 A1
(43) Pub. Date: Jan. 3, 2019

(54) Signal Matching for Entity Resolution

(71) Applicant: Quaero, Charlotte, NC (US)

(72) Inventors: Dan SMITH, Cornelius, NC (US); John RISTUCCIA, Windham, NH (US); Nitin KAK, Charleston, SC (US)

(73) Assignee: Quaero, Charlotte, NC (US)

(21) Appl. No.: 16/065,162

(22) PCT Filed: Jan. 21, 2017
(86) PCT No.: PCT/US2017/014464

§ 371 Date: Jun. 22, 2018

Related U.S. Application Data
(60) Provisional application No. 62/286,522, filed on Jan. 25, 2016.

(51) Int. Cl. G06Q 30/02

(52) U.S. Cl. CPC G06Q 30/0244; G06Q 30/0201; G06Q 30/0251

(57) ABSTRACT

This invention presents a method for storing and synthesizing data that enables continual entity resolution exploiting both newly received data and historically stored data to create and maintain an accurate and complete profile of each individual consumer for the purposes of optimizing the effectiveness of digital marketing and advertising. It uses techniques that effectively handle the voluminous data which is typical in this industry without requiring excessive storage or processing capacity and yields a more accurate representation of entities than other similar methods.

### 35 U.S.C. § 365 RIGHT OF PRIORITY

This national stage patent application claims a right of priority under 35 U.S.C. § 365 to International Application No. PCT/US2017/014464 filed Jan. 21, 2017, which claims priority to U.S. Provisional Application No. 62/286,522 filed Jan. 25, 2016, with both applications incorporated herein by reference in their entireties.

### BACKGROUND

Entity resolution can be defined as “the task of disambiguating manifestations of real world entities in various records or mentions by linking and grouping.” The accuracy of an entity resolution system is inherently dependent on the quality and completeness of data presented to it. In consumer marketing and advertising, the entity of interest is a person, and having accurate identifiers and profiles for each person is critical for success. However, at any given point in time, the data presented to the system may be incomplete, sparse, biased or presented chronologically out of order. This presents a challenge to entity resolution. If only signals in the new data are considered, then the matching results will be incomplete and any effects of new signals on previous entities will be ignored. However, if historical signals—all signals in all data ever received—are considered holistically, then the resources required to store and match all signals, establish chains between signals, establish new entities, and apply changes to existing entities and their dependents, can become unreasonable. This is particularly true in digital consumer marketing and advertising as the data that contains the matching signals is so voluminous.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a flowchart illustrating a method for signal, entity and entity dependency management according to exemplary embodiments; and

FIG. 2 illustrates an operating environment, according to exemplary embodiments.

### SUMMARY

This invention presents a method for storing and synthesizing data that enables continual entity resolution exploiting both newly received data and historically stored data to create and maintain an accurate and complete profile of each individual consumer for the purposes of optimizing the effectiveness of digital marketing and advertising. It uses techniques that effectively handle the voluminous data which is typical in this industry without requiring excessive storage or processing capacity and yields a more accurate representation of entities than other similar methods.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

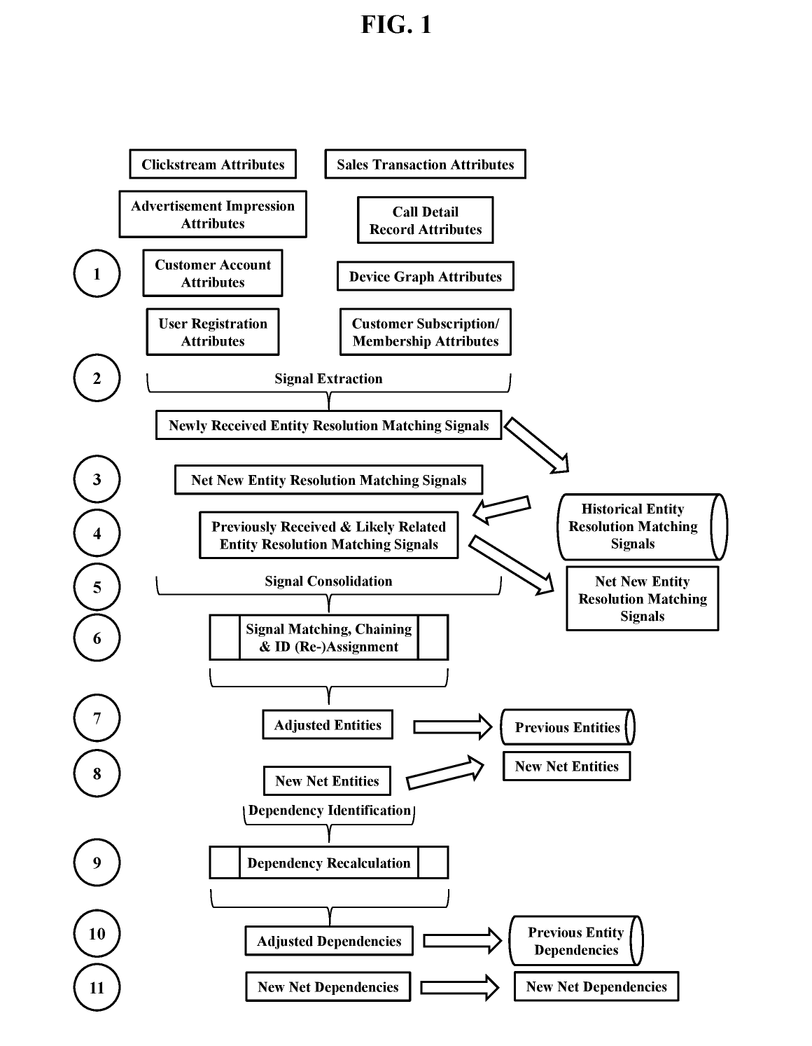

FIG. 1 is a flowchart illustrating a method for signal, entity and entity dependency management according to exemplary embodiments. A variety of disparate input data sources (1) can be used. Within clickstream data, for example, each record represents the request, presentation and consumption of digital content from devices such as laptops, tablets, mobile phones and gaming consoles. Attributes germane to a clickstream record which are typically useful for matching include session id, device ID, cookie, IP address, user ID, and browser or mobile app footprint. Within device graph data, each record represents the linkage between two devices, or specifically, two device identifiers. Within customer account data, each record represents a person's account with a business entity that sells that customer a product or service. Attributes germane to customer account data include account ID, customer name, terrestrial address, email address, and phone number.

The input data sources are examined for signals which are deemed valuable for the purpose of linking data which is truly associated with a particular person to the single identifier assigned to that particular person, and conversely, ensuring that data which is not truly associated with a particular person is not linked to the identifier assigned to that particular person. There are no restrictions regarding which data can be used, provided useful signals within the data can be mapped and extracted.

Signals which have been pre-mapped to the newly available data are extracted (2). Only unique combinations of signal values are extracted, as redundant combinations use additional resources and provide no extra value. This is a particularly important step for Big Data such as clickstream or digital advertising impressions.

Unique combinations of signal values extracted from the new data are then compared to the historically stored signal combinations and from that comparison net new signal combinations are identified (3). Unique combinations in this sense means unique combinations of exact values of all available signals. The net new signal combinations identified are then compared to historically stored signal combinations in order to find potential linkage (4). Of course since these unique signal combinations are net new, all elements in a given combination cannot, by definition, match all elements exactly in a historical signal combination. However, the matching will be done using fuzzy matching and weighted, multi-element scoring to be compared against a threshold for pass or fail. For example, given the following two signal combinations:

| Signal 1 | Signal 2 | Signal 3 |
|---|---|---|
| ABC | DEF | GHI |
| ACB | DEF | 123 |

The matching algorithm might match these two signal combinations even though they are not an exact match as long as the sum of the weighted scores of each elements degree of matching exceeds an acceptable threshold. In the example above, the first signal has a single digit transposition, the second signal is an exact match and the third signal does not match at all. Depending on the algorithm configuration, these two combinations might match if the exact match plus the near match (the first signal with one digit transposed) exceeds the acceptable threshold.

A very loose matching algorithm is used in order to extract candidates from the historical signals which are at least somewhat likely to match (i.e. using a multi-part, weighted, threshold comparison approach), while ignoring those which are highly unlikely to match. This is a particularly important step since the historical data is inherently voluminous and constantly growing. This is done using regular expression-like pattern matching with Boolean (and/or) logic which acts like a crude simulation of the actual matching that will occur subsequently, but it's much faster than the actual matching. An example expression expressed in colloquial language might be “extract signal combinations where the historical signal one is within 80% string distance of one of the net new signal combinations OR the first and last two characters of the net new and historical signal two are the same”. The simulated match expressions should be tuned periodically to ensure the optimal balance between precision of match candidates and resources to find and extract them.

For each historical signal identified as a potential match to a new signal, all signals previously linked to the associated entity are also extracted (i.e. previously assigned the same persistent identifier). For example, if new signals are received which have some similarity to historical signals previously received and linked to John Smith, then all signals previously linked to John Smith are extracted. This ensures that the processing of new signals will not only have an opportunity to match against historical signals but also have the opportunity to change the composition of previously resolved entities. This is important to account for cases when the presence of the new signals would have changed the entity resolution results, if they have been available at the time the older signals were processed. For example, if John Smith anonymously browsed the website of Acme Inc. on both his laptop and iPhone, the entity resolution would likely resolve that behavior into two entities. If later, device graph data—data that links devices—is received and processed as new signals, all of John Smith's historical signals will be extracted and processed along with the new device linkage signals and the entities will be combined into one. This is a significant benefit of continual entity resolution using historical signals; exemplary embodiments uses new signals in conjunction with historical signals and previously established entity definitions post facto to reveal a previously unknown common entity. This addresses the challenges of sparse and out-of-order signals.

Reprocessing of historical signals loosely related to new signals also enhances the effectiveness of “chaining”, also known as “transitive closure”. For example, consider the scenario where signals were initially received for Mary Smith who then later changed her name to Mary Brown, and then later, after the name change, additional signals were received for Mary, except with her previous surname, Smith. If the new signals for Mary which contain her previous surname (Smith) were compared only to the latest signals for Mary which contain her current surname (Brown) then matching the new signals to the current entity would likely not occur. In this case, the signals with surname Brown may have been linked to signals with surname Smith by a customer account ID from one system, or a cookie. Retaining and matching against the entire historical universe of all signals related to an entity is required to accomplish this linkage. The use of historical signals and chaining is illustrated in the following.

| Record # | Surname | Account ID | Chaining |
|---|---|---|---|
| 1 | Brown | 123 | 1 matches 2 based |
| | | | on Account ID |
| | | | 1 matches 3 based |
| | | | on chaining |
| | | | through 2 |
| 2 | Smith | 123 | 2 matches 1 based |
| | | | on Account ID |
| | | | 2 matches 3 based |
| | | | on surname |
| 3 | Smith | [blank/ | 3 matches 2 based |
| | | unknown] | on surname |
| | | | 3 matches 1 based |
| | | | on chaining |
| | | | through 2 |

The net new, and previously received but likely related signals, are consolidated (5). The consolidated set of signals is then processed through multiple passes of matching (6), using established matching logic such as fuzzy (e.g. string distance) matching, sorted neighborhood, multi-signal weighted score thresholds, and chaining (aka transitive closure e.g. if A=B, and B=C, then A=C).

Exemplary embodiments employ a unique and novel method for sorting arrays of related device IDs in order to maximize matching within the sorted neighborhood algorithm. Some sources of data, such as device graphs, provide linkages between devices. This device linkage data can be appended to any data that contains a device ID and used as additional signals for matching. Exemplary embodiments store device linkage data in a related device ID array. For example, if a particular phone (ID=1), tablet (ID=2) and laptop (ID=3) are related, the related device ID array would contain (1, 2, 3). Related device ID arrays are used as signals for matching and as such, are compared for similarity between records. Similarity in this case is measured by degree of intersection.

| | | | Degree of |
|---|---|---|---|
| Example # | Related ID Array #1 | Related ID Array #2 | Intersection |
| 1 | 1, 2, 3 | 1, 2, 3 | High |
| 2 | 1, 2, 3 | 2, 3, 4 | Medium |
| 3 | 1, 2, 3 | 3, 4, 5 | Low |

It is important to note that, as illustrated above, the related device ID arrays are not always a complete chain. This can occur due to timing issues, for example at T=1 the array or devices related to device 1 is (2, 3), but at T=2 it is (3, 4). It can also occur due to incomplete data. This could be addressed by a combination of applying the transitive property to all data before matching (e.g. if 1 is related to 2 and 2 is related to 3 then 1, 2 and 3 are all related) and retroactively applying current relationships backward in time (e.g. if 1, 2, and are all related today, then 1, 2 and 3 were always related). However, exemplary embodiments use a sort method instead.

Because matching each signal to every other signal would require excessive time and processing capacity, the sorted neighborhood method is used and thus signals to be matched must first be sorted such that potential matches are near enough to one another that they will fit within the same sliding window. Sorting the related device ID arrays to achieve this objective can be a challenge, as illustrated in examples #2 and #3 in table 1 above since a standard lexical sort will not work.

Exemplary embodiments does this by reverse indexing records and then sorting on related device id. Consider the tuple of record objects and the corresponding related device ids below.

| Record Object | Related Device IDs |
|---|---|
| [a] | 1, 2 |
| [b] | 1, 3 |
| [c] | 2, 3 |
| [d] | 1, 4 |

This tuple will be reverse index it and sort on the related device ID which then turns into the following.

| | | Related Device |
|---|---|---|
| Related Device ID | Record | IDs |
| 1 | [a] | 1, 2 |
| 1 | [b] | 1, 3 |
| 1 | [d] | 1, 4 |
| 2 | [a] | 1, 2 |
| 2 | [c] | 2, 3 |
| 3 | [b] | 1, 3 |
| 3 | [c] | 2, 3 |
| 4 | [d] | 1, 4 |

The rows where the related device ids share at least one device id will be put next to each other. This ensures not only that they will fit within the sliding window, but will in fact, be adjacent to one another. As illustrated above, this does create duplication (e.g. each record is repeated multiple times) but that does not affect the integrity of the matching results.
It's important to note that all records which share a related device ID might not match. This is because the threshold set in the matching rules might be reached only if there are more than 1 related device ids matching. It's also worth noting that the order of records which share the same related device ID is nondeterministic.

The result of all the signal matching is a set of clusters of signals, where each cluster contains the signals that have been matched. Each unique cluster of matched signals is assigned a unique and persistent identifier (6). If a cluster contains historical signals that were previously assigned an identifier, then the previously assigned identifier is re-used. If multiple previously assigned identifiers are contained in a single cluster, then the oldest identifier is used. This minimizes impact when entities are adjusted differently during subsequent entity resolution processing.

The adjusted (7) and net new (8) entities are stored, along with linkage to all related signals, new and historical. This includes any external identifiers, such as account numbers, student IDs, user IDs, device IDs, email addresses, etc. It also includes attributive information such as names, addresses, phone numbers, device types, etc. and behavioral information such as IP addresses, affinities and preferences, content consumption, logins, etc. All signals are correlated as electronic associations to the single entity identifier.

The exemplary embodiments maintains a dependency map between all entities so that when entity resolution changes the composition of an entity, data which is dependent on the composition of an entity can be adjusted accordingly, and the integrity of the data system overall can be maintained. For example, if at a particular point in time, John Smith's online purchase history is resolved into one entity, and his retail store purchase history is resolved into a second entity, and then later they are linked and combined into a single entity, then any derivations that take into account all of John's information—for example, customer lifetime value—will be affected. Exemplary embodiments interrogates the dependency map to identify all dependencies (9) that have been affected after entity resolution occurs.

The exemplary embodiments then recalculate dependent data (10) and using that recalculation update adjusted (11) dependencies and dependencies for net new entities (12).

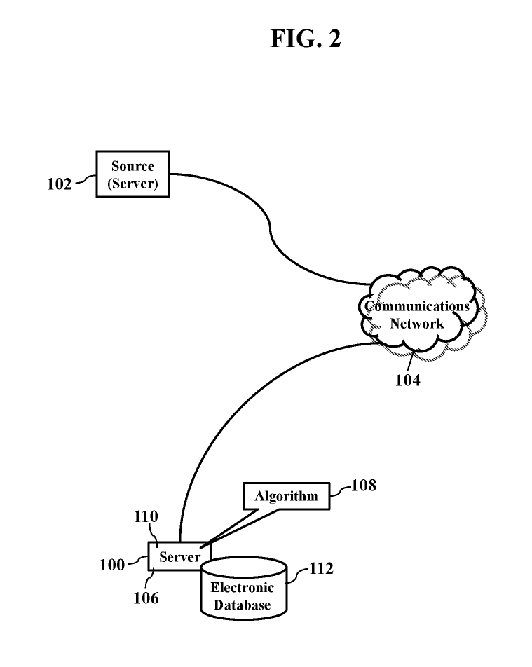

FIG. 2 illustrates an operating environment, according to exemplary embodiments. FIG. 2 illustrates a server 100 communicating with any source 102 via a communications network 104. As this disclosure explains, the source 102 may provide one or multiple continuous streams of clickstream data, attributes related to sales transactions, attributes associated with advertising impressions, call detail records, attributes associated with customer accounts, attributes associated with device graphs, attributes associated with user registrations, and/or attributes associated with subscription/membership rosters. The server 100 may determine both the newly received data and the historically stored data to create and maintain accurate and complete profiles of individual consumers (as above explained). The server 100 has a processor 106, application specific integrated circuit (ASIC), or other component that executes an algorithm 108 stored in a local memory device 110. The algorithm 108 instructs the processor 106 to perform operations, such as receiving both the newly received data and the historically stored data from a network interface to the communications network 104. The algorithm 108 may cause the processor 106 to query one or more electronic database 112 and to retrieve or identify matching or non-matching database entries. For example, the electronic database 112 may have entries that electronically associate different combinations of signal values to the persistent identifier. The algorithm 108 may thus determine one or more unique combinations of electronic signals contained within the stream of electronic signals that fail to match the combinations of signal values in the electronic database that are known to be associated with the persistent identifier. The electronic database 112 may also store entries representing historical combinations of signal values that are known to be associated with the persistent identifier.

Information may be received as packets of data according to a packet protocol (such as any of the Internet Protocols). The packets of data contain bits or bytes of data describing the contents, or payload, of a message. A header of each packet of data may contain routing information identifying an origination address and/or a destination address. The algorithm, for example, may instruct the processor to inspect packetized information for network addresses (e.g., IP address), cellular identifiers (e.g., telephone number, MSISDN), and/or any other data contained within header or payload.

Exemplary embodiments may be applied regardless of networking environment. Exemplary embodiments may be easily adapted to stationary or mobile devices having cellular, WI-FI®, near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

1. A method, comprising:
receiving, by a server, a stream of electronic signals sent via the Internet from a source;
comparing, by the server, the stream of electronic signals to combinations of signal values known to be associated with a persistent identifier, the persistent identifier uniquely identifying a user;
determining, by the server, a unique combination of electronic signals contained within the stream of electronic signals, the unique combination of electronic signals failing to match the combinations of signal values known to be associated with the persistent identifier;
retrieving, by the server, historical combinations of signal values known to be associated with the persistent identifier;
determining, by the server, a score associated with a comparison of the unique combination of electronic signals to the historical combinations of signal values known to be associated with the persistent identifier, the score based on exact matches and near matches between the unique combination of electronic signals and the historical combinations of signal values;
comparing, by the server, the score to a threshold value for linking to the persistent identifier;
determining, by the server, an unknown common entity between the unique combination of electronic signals and the historical combinations of signal values in response to the score satisfying the threshold value; and
assigning, by the server, the unknown common entity to the persistent identifier;
wherein the unknown common entity is consolidated with the user uniquely identified by the persistent identifier.

2. The method of claim 1, further comprising extracting clickstream data as the stream of electronic signals.

3. The method of claim 1, further comprising extracting advertising impressions as the stream of electronic signals.

4. The method of claim 1, further comprising extracting call records as the stream of electronic signals.

5. The method of claim 1, further comprising extracting device graphs as the stream of electronic signals.

6. The method of claim 1, further comprising extracting subscription records as the stream of electronic signals.

7. The method of claim 1, further comprising extracting transaction records as the stream of electronic signals.

8. The method of claim 1, further comprising consolidating the unique combination of electronic signals with the historical combinations of signal values in response to the score satisfying the threshold value.

9. The method of claim 1, further comprising consolidating the stream of electronic signals with the historical combinations of signal values in response to the score satisfying the threshold value.

10. The method of claim 1, further comprising generating a group of multiple unique combinations of electronic signals that match the historical combinations of signal values.

11. The method of claim 10, further comprising assigning the group of multiple unique combinations of electronic signals to the persistent identifier.

12. The method of claim 1, further comprising extracting all signals historically associated with the persistent identifier in response to the score satisfying the threshold value.

13. The method of claim 12, further comprising combining the stream of electronic signals with the all the signals historically associated with the persistent identifier.

14. A system, comprising:
a hardware processor; and
a memory device, the memory device storing instructions, the instructions when executed causing the hardware processor to perform operations, the operations comprising:
receiving a stream of electronic signals sent via the Internet from a source;
determining a persistent identifier that uniquely identifies a user;
querying an electronic database for values associated with the stream of electronic signals, the electronic database electronically associating combinations of signal values to the persistent identifier;
determining a unique combination of electronic signals contained within the stream of electronic signals that fails to match the combinations of signal values in the electronic database that are known to be associated with the persistent identifier;
querying the electronic database for the persistent identifier, the electronic database electronically associating the persistent identifier to historical combinations of signal values;
retrieving the historical combinations of signal values from the electronic database that are known to be associated with the persistent identifier;
comparing the unique combination of electronic signals to the historical combinations of signal values known to be associated with the persistent identifier;
determining a score associated with a comparison of the unique combination of electronic signals to the historical combinations of signal values known to be associated with the persistent identifier, the score based on exact matches and near matches between the unique combination of electronic signals and the historical combinations of signal values;
comparing the score to a threshold value for linking to the persistent identifier;
determining an unknown common entity between the unique combination of electronic signals and the historical combinations of signal values in response to the score satisfying the threshold value; and
assigning the unknown common entity to the persistent identifier;
wherein the unknown common entity is consolidated with the user uniquely identified by the persistent identifier.

15. The system of claim 14, where the operations further comprise assigning the unknown common entity to the unique combination of electronic signals that fails to match the combinations of signal values in the electronic database that are known to be associated with the persistent identifier.

16. The system of claim 14, where the operations further comprise consolidating the unique combination of electronic signals with the historical combinations of signal values in response to the score satisfying the threshold value.

17. The system of claim 14, where the operations further comprise consolidating the stream of electronic signals with the historical combinations of signal values in response to the score satisfying the threshold value.

18. A memory device storing instructions that when executed cause a hardware processor to perform operations, the operations comprising:
receiving a stream of electronic signals sent via the Internet from a source;
determining a persistent identifier that uniquely identifies a user;
querying an electronic database for values associated with the stream of electronic signals, the electronic database electronically associating combinations of signal values to the persistent identifier;
determining a unique combination of electronic signals contained within the stream of electronic signals that fails to match the combinations of signal values in the electronic database that are known to be associated with the persistent identifier;
querying another electronic database for the persistent identifier, the another electronic database electronically associating persistent identifier to historical combinations of signal values;
retrieving the historical combinations of signal values from the another electronic database that are known to be associated with the persistent identifier;
comparing the unique combination of electronic signals to the historical combinations of signal values known to be associated with the persistent identifier;
determining a score associated with a comparison of the unique combination of electronic signals to the historical combinations of signal values known to be associated with the persistent identifier, the score based on exact matches and near matches between the unique combination of electronic signals and the historical combinations of signal values;
comparing the score to a threshold value for linking to the persistent identifier;
determining an unknown common entity between the unique combination of electronic signals and the historical combinations of signal values in response to the score satisfying the threshold value; and
assigning the unknown common entity to the persistent identifier;
wherein the unknown common entity is consolidated with the user uniquely identified by the persistent identifier.

19. The memory device of claim 18, where the operations further comprise assigning the unknown common entity to the unique combination of electronic signals that fails to match the combinations of signal values in the electronic database that are known to be associated with the persistent identifier.

20. The memory device of claim 18, where the operations further comprise consolidating the unique combination of electronic signals with the historical combinations of signal values in response to the score satisfying the threshold value.
